(19) United States
(12) Patent Application Publication
(10) Pub. No.: US 2017/0227112 A1
(43) Pub. Date: Aug. 10, 2017

(54) Engine And Transmission Spacer With Integrated Hydraulic Tank

(71) Applicants: David Blomberg, Dent, MN (US); Thomas Warmoth, Lake Geneva, WI (US); Jun Li, Hunan (CN); Qing Li, Hunan (CN)

(72) Inventors: David Blomberg, Dent, MN (US); Thomas Warmoth, Lake Geneva, WI (US); Jun Li, Hunan (CN); Qing Li, Hunan (CN)

(21) Appl. No.: 15/015,457

(22) Filed: Feb. 4, 2016

(51) Int. Cl. F16H 57/04; F16H 57/025; F01M 11/04; F01M 1/02; F01M 11/00

(52) U.S. Cl. CPC F16H 57/045; F01M 1/02; F01M 11/0004; F01M 11/04; F16H 57/025; F16H 57/0424

(57) ABSTRACT

An engine and transmission spacer with integrated hydraulic tank preferably includes a spacer case, an engine flange and a transmission flange. The spacer case includes an outer peripheral wall, a first outer wall and a second outer wall. The first outer wall is formed on one end of the outer peripheral wall and the second outer wall is formed on an opposing end of the outer peripheral wall. The engine flange extends from one end of the spacer case and the transmission flange extends from the opposing end thereof. A fluid cavity is formed in an inner surface of the outer peripheral wall, the first outer wall and the second outer wall. At least one pump port is preferably formed through a side of the outer peripheral wall. An oil pump is used to transfer fluid from the fluid cavity to another location.

### BACKGROUND OF THE INVENTION

1. Field of the Invention

The present invention relates generally to large mechanical equipment and more specifically to an engine and transmission spacer with integrated hydraulic tank, which utilizes an existing spacer between an engine and transmission as a hydraulic tank.

2. Discussion of the Prior Art

It appears that the prior art does not disclose an engine and transmission spacer with integrated hydraulic tank.

Accordingly, there is a clearly felt need in the art for an engine and transmission spacer with integrated hydraulic tank, which utilizes an existing spacer between an engine and transmission as hydraulic tank reservoir.

### SUMMARY OF THE INVENTION

The present invention provides an engine and transmission spacer with integrated hydraulic tank, which utilizes an existing spacer between an engine and transmission as a hydraulic tank. The engine and transmission spacer with integrated hydraulic tank (spacer with hydraulic tank) preferably includes a spacer case, an engine flange and a transmission flange. The spacer case includes an outer peripheral wall, a first outer wall and a second outer wall. The first outer wall is formed on one end of the outer peripheral wall and the second outer wall is formed on an opposing end of the outer peripheral wall. The engine flange extends outward from an outer perimeter of the one end of the spacer case and the transmission flange extends from an outer perimeter of the opposing end of the spacer case. An engine drive shaft tube extends from the first outer wall to the second outer wall. A transmission drive shaft tube extends from the first outer wall to the second outer wall. A fluid cavity is formed in an inner surface of the outer peripheral wall, the first outer wall and the second outer wall. The fluid cavity is capable of retaining a quantity of oil, such as hydraulic oil. At least one pump port is preferably formed through a side of the outer peripheral wall to remove oil from the fluid cavity. A fill port is preferably formed through the outer peripheral wall near a top thereof to fill the fluid cavity. The shaft tubes do not fluidly communicate with the fluid cavity.

The engine flange of the spacer with hydraulic tank is secured to a rear flange of an engine with a plurality of fasteners. An engine drive shaft is inserted through the engine drive shaft tube into the engine. A transmission drive shaft of the transmission is inserted through the transmission drive shaft tube and a front flange of the transmission is secured to the transmission with a plurality of fasteners. An oil pump is used to transfer fluid from the fluid cavity to another location. The oil pump is preferably driven by an output shaft of the transmission. An input hose of the oil pump is preferably connected to the at least one pump port in a side of the outer peripheral wall.

Accordingly, it is an object of the present invention to provide a spacer with hydraulic tank, which utilizes existing spacer between an engine and transmission as a hydraulic tank reservoir.

These and additional objects, advantages, features and benefits of the present invention will become apparent from the following specification.

### BRIEF DESCRIPTION OF THE DRAWINGS

FIG. 1 is a perspective view of a spacer with hydraulic tank in accordance with the present invention.

FIG. 2 is a side cross sectional view cut through FIG. 1 of a spacer with hydraulic tank in accordance with the present invention.

FIG. 3 is an end cross sectional view cut through FIG. 1 of a spacer with hydraulic tank in accordance with the present invention.

FIG. 4 is a side cross sectional view cut with a spacer with hydraulic tank attached to an internal combustion engine on one end and a transmission on the other end in accordance with the present invention.

FIG. 5 is a schematic diagram of a spacer with hydraulic tank in accordance with the present invention.

### DETAILED DESCRIPTION OF THE PREFERRED EMBODIMENTS

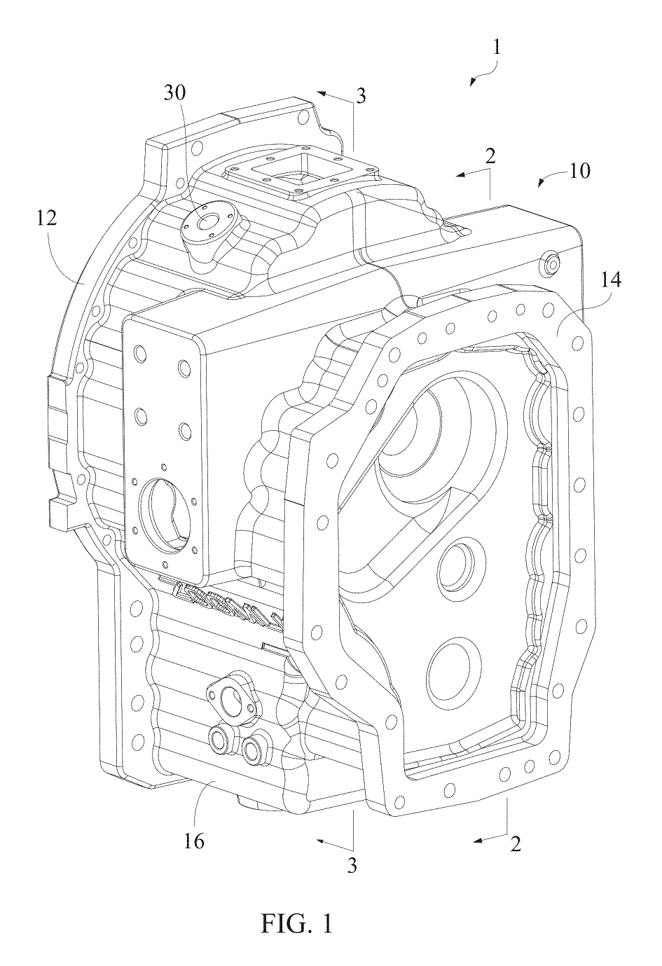

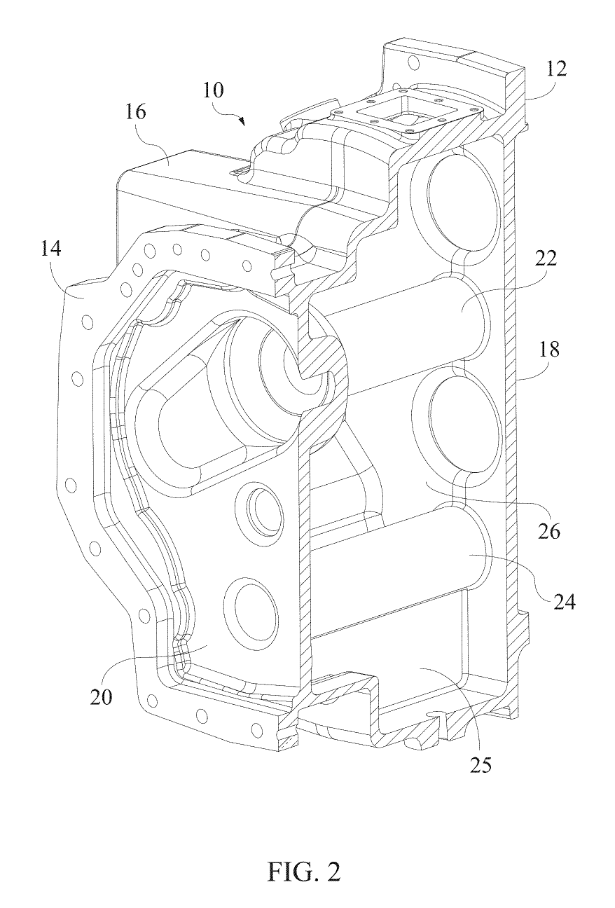

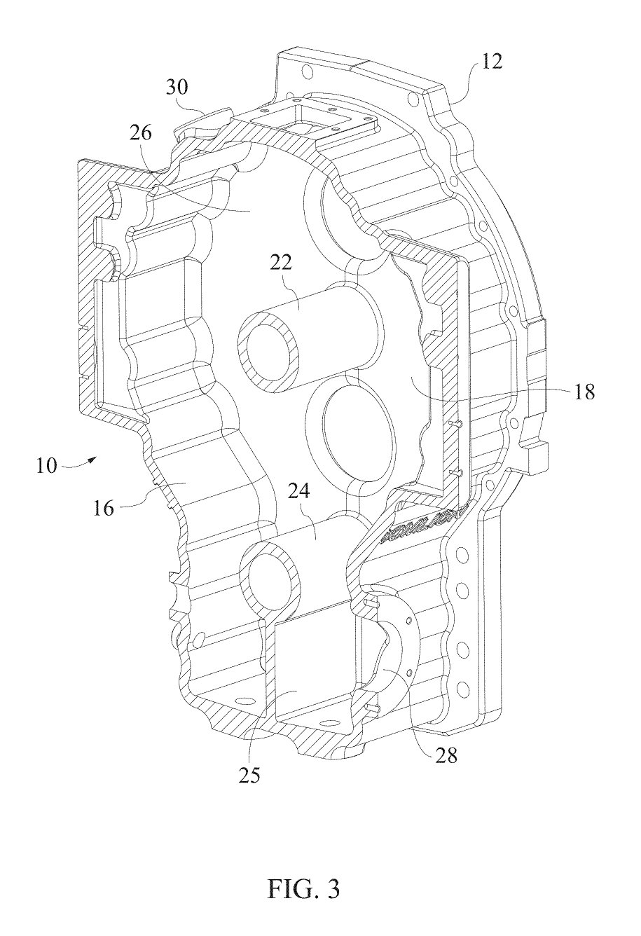

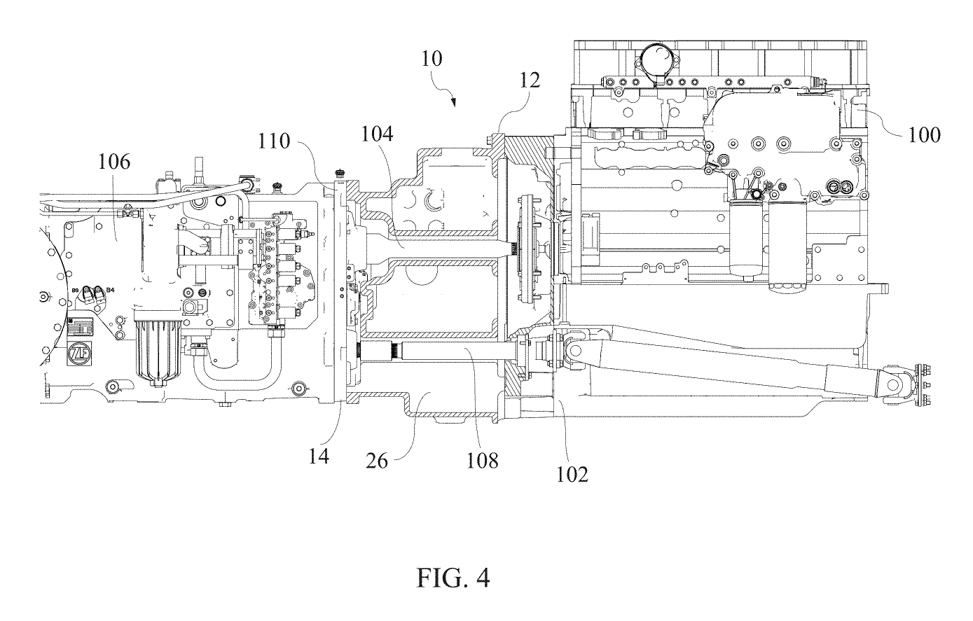

With reference now to the drawings, and particularly to FIG. 1, there is shown a perspective view of a spacer with hydraulic tank 1. With reference to FIGS. 2-4, the spacer with hydraulic tank 1 preferably includes a spacer case 10, an engine flange 12 and a transmission flange 14. The spacer case 10 includes an outer peripheral wall 16, a first outer wall 18 and a second outer wall 20. The first outer wall 18 is formed adjacent on one end of the outer peripheral wall 16 and the second outer wall 20 is formed on an opposing end of the outer peripheral wall 16. The engine flange 12 extends outward from an outer perimeter of the one end of the spacer case 10 and the transmission flange 14 extends from an outer perimeter of the opposing end of the spacer case 10. An engine drive shaft tube 22 extends from an inner surface of the first outer wall 18 to an inner surface of the second outer wall 20. A transmission drive shaft tube 24 extends from the inner surface of the first outer wall 18 to the inner surface of the second outer wall 20. The transmission drive shaft tube 24 is located below the engine drive shaft tube 22. A baffle 25 preferably extends downward from the shaft tube 24 to the outer peripheral wall 16. A fluid cavity 26 is formed in an inner surface of the outer peripheral wall 16, the first outer wall 18 and the second outer wall 20. The fluid cavity 26 is capable of retaining a quantity of fluid, such as hydraulic oil. At least one pump port 28 is preferably formed through a side of the outer peripheral wall 16 to remove hydraulic oil from the fluid cavity 26. A fill port 30 is preferably formed through the outer peripheral wall 16 near a top thereof to fill the fluid cavity 26. The shaft tubes 22, 24 do not fluidly communicate with the fluid cavity 26.

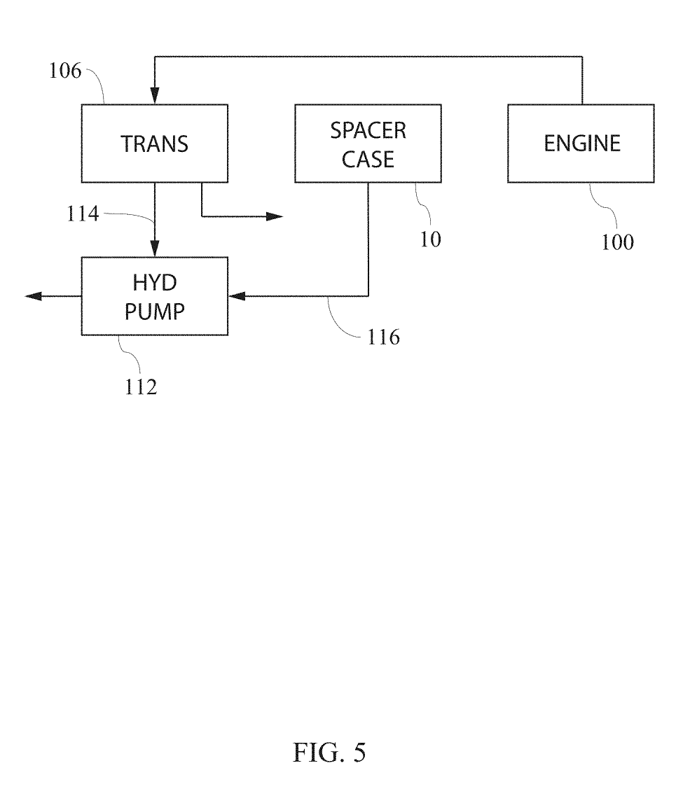

The engine flange 12 of the spacer with hydraulic tank 1 is secured to a rear flange 102 of an engine 100 with a plurality of fasteners. An engine drive shaft 104 is inserted through the engine drive shaft tube 22 into the engine 100. A transmission drive shaft 108 of a transmission 106 is inserted through the transmission drive shaft tube 24 and a front flange 110 of the transmission 106 is attached to the transmission flange 14 with a plurality of fasteners. With reference to FIG. 5, an oil pump 112 is used to transfer fluid from the fluid cavity 26 to another location. The oil pump 112 is preferably driven by an output shaft 114 of the transmission 106. One end of an input hose 116 is connected to an input port of the oil pump 112 and the other end of the input hose 116 is connected to the at least one pump port 28 in a bottom of the outer peripheral wall 16.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

I claim:

1. A spacer with hydraulic tank comprising:
a spacer case includes an outer peripheral wall, a first outer wall and a second outer wall, said first outer wall is formed on one end of said outer peripheral wall, said second outer wall is formed on an opposing end of said outer peripheral wall, a fluid cavity is formed in an inner surface of said outer peripheral wall, said first outer wall and said second outer wall, said fluid cavity is capable of retaining a quantity of fluid;
an engine flange is formed on one end of said spacer case; and
a transmission flange is formed on an opposing end of said spacer case.

2. The spacer with hydraulic tank of claim 1 wherein:
at least one pump port is formed through said outer peripheral wall to transfer the quantity of fluid from said fluid cavity.

3. The spacer with hydraulic tank of claim 1 wherein:
a fill port is formed through said outer peripheral wall to fill said fluid cavity.

4. The spacer with hydraulic tank of claim 1 wherein:
an oil pump having an input coupled to said at least one pump port.

5. The spacer with hydraulic tank of claim 4 wherein:
the oil pump is driven by an output shaft of the transmission.

6. A spacer with hydraulic tank comprising:
a spacer case includes an outer peripheral wall, a first outer wall and a second outer wall, said first outer wall is formed on one end of said outer peripheral wall, said second outer wall is formed on an opposing end of said outer peripheral wall, a fluid cavity is formed in an inner surface of said outer peripheral wall, said first outer wall and said second outer wall, said fluid cavity is capable of retaining a quantity of fluid, at least one drive shaft tube is formed from an inner surface of said first outer wall to an inner surface of said second outer wall;
an engine flange is formed on one end of said spacer case; and
a transmission flange is formed on an opposing end of said spacer case.

7. The spacer with hydraulic tank of claim 6 wherein:
at least one pump port is formed through said outer peripheral wall to transfer the quantity of fluid from said fluid cavity.

8. The spacer with hydraulic tank of claim 6 wherein:
a fill port is formed through said outer peripheral wall to fill said fluid cavity.

9. The spacer with hydraulic tank of claim 6 wherein:
an oil pump having an input coupled to said at least one pump port.

10. The spacer with hydraulic tank of claim 9 wherein:
the oil pump is driven by an output shaft of the transmission.

11. A spacer with hydraulic tank comprising:
a spacer case includes an outer peripheral wall, a first outer wall and a second outer wall, said first outer wall is formed on one end of said outer peripheral wall, said second outer wall is formed on an opposing end of said outer peripheral wall, a fluid cavity is formed in an inner surface of said outer peripheral wall, said first outer wall and said second outer wall, said fluid cavity is capable of retaining a quantity of fluid, at least one drive shaft tube is formed from an inner surface of said first outer wall to an inner surface of said second outer wall, said at least one shaft tube does not fluidly communicate with said fluid cavity;
an engine flange is formed on one end of said spacer case; and
a transmission flange is formed on an opposing end of said spacer case, wherein said transmission flange is secured to a transmission flange of a transmission, said engine flange is secured to an engine flange of said engine.

12. The spacer with hydraulic tank of claim 11 wherein:
at least one pump port is formed through said outer peripheral wall to transfer the quantity of fluid from said fluid cavity.

13. The spacer with hydraulic tank of claim 11 wherein:
a fill port is formed through said outer peripheral wall to fill said fluid cavity.

14. The spacer with hydraulic tank of claim 11 wherein:
an oil pump having an input coupled to said at least one pump port.

15. The spacer with hydraulic tank of claim 14 wherein:
the oil pump is driven by an output shaft of the transmission.
